(19) United States
(12) Patent Application Publication
(10) Pub. No.: US 2025/0267340 A1
(43) Pub. Date: Aug. 21, 2025

(54) SYSTEM, METHOD AND APPARATUS FOR IMPROVING AUDIO RECORDINGS OF LIVE EVENTS

(71) Applicants: Mark Baldi, Rancho Santa Fe, CA (US); Michael Lamb, Rancho Santa Fe, CA (US); Brett Worthington, Rancho Santa Fe, CA (US)

(72) Inventors: Mark Baldi, Rancho Santa Fe, CA (US); Michael Lamb, Rancho Santa Fe, CA (US); Brett Worthington, Rancho Santa Fe, CA (US)

(73) Assignee: Livewired, LLC, Carlsbad, CA (US)

(21) Appl. No.: 19/060,574

(22) Filed: Feb. 21, 2025

Related U.S. Application Data
(60) Provisional application No. 63/556,135, filed on Feb. 21, 2024.

(51) Int. Cl. H04N 21/81; H04N 21/2187; H04N 21/43; H04N 21/439

(52) U.S. Cl. CPC H04N 21/8106; H04N 21/2187; H04N 21/43072; H04N 21/4394

(57) ABSTRACT

A system, apparatus and method are described for enhancing the quality of livestream videos sourced from live events, including audio components of livestream videos. Audio recordings are generated by spectators at a live event and streamed to an media production server. The audio recordings typically overlap in time, capturing particular portions of the live event. The media production server receives the audio recordings and determines one or more audio characteristics of each audio recording, in some cases, using a trained AI model. A subset of audio recordings is selected for mixing based on the determined audio characteristics to produce a composite audio track. The composite audio track may then be substituted for each of the audio recordings.

### CROSS-REFERENCE TO RELATED APPLICATIONS

This present application claims the benefit of U.S. provisional patent application No. 63/556,135, filed on Feb. 21, 2024.

### BACKGROUND

### Field of Use

The present invention generally relates to acoustical reproduction and sound field reconstruction. More specifically, it relates to methods and apparatus for audio and video capture and processing, and in particular, to spatial or enhanced audio produced from a plurality of sound sources captured from different locations at live events.

### Description of the Related Art

In recent years, people have been using their mobile electronic devices, such as mobile phones, to record and livestream live events, such as concerts, sporting events, etc. Online services exist today that capture such livestream videos from different spectators at a live event and allows online viewers to watch the live event in real-time, or near real-time as an event is occurring.

Stereo audio uses two channels to create the illusion of multidirectional sound, which adds greater depth and dimension to your audio and results in an immersive listening experience. Immersive or “spatial” audio employs at least two microphones. Recording a 360 degree horizontal surround audio scene requires at least 3 audio channels, while recording a three dimensional audio scene requires at least 4 audio channels. It is desirable to reproduce a spatial audio scene for a listener, which is a substantially accurate representation of the captured audio scene (for example a user-generated livestream video of a live music event). However, the audio content captured with mobile devices, and the ability to create the illusion of multidirectional sound to produce an immersive listening experience, is fundamentally limited by the user's position at the event. Full spectrum audio can only be captured from the center of the stereo image, physically equidistant from all of the event's loudspeakers. Users who are positioned away from this optimal location causes sound quality to degrade. Additional problems are presented when using a single microphone mobile device to precisely record and reproduce sound produced by a plurality of sound sources (for example, a single user producing user-generated content at a live music event). One significant problem encountered when trying to reproduce sounds from a plurality of sound sources is the inability of a single microphone to recreate the sonic properties of depth and width. Another problem arises when the user's recording device is in a position too close or too far from a specific sound frequency source (for example, a device that is receiving only a bass speaker signal, and no other frequencies, or too close to a specific instrument signal, for example a position that is only receiving the drums audio, and not other instruments). Another significant problem is crowd noise, encountered when a user is recording from a location of loud ambient crowd noise (for example, an audience signing at a live music event).

The recording of live audio and video in user-generated content (for example, a livestream video of a live music event) has become increasingly popular with the advancement of mobile smartphones. Mobile device users are able to livestream or record live events (for example live music events) and share their videos (for example, to social media platforms). However, while the video quality captured in user-generated content has continued to improve with the devices, the quality of the accompanying audio content captured by mobile devices is limited. While improvements have been made to mobile devices to utilize multiple microphones within the device to add stereo-recording capabilities, the ability to capture the full stereo image of a live music event using a mobile device is fundamentally limited because full spectrum audio can only be captured by a single microphone recording device when the device is at the absolute center of the stereo image, physically equidistant from all of the event's loudspeakers. Users who are positioned away from this optimal location causes sound quality to degrade.

As user-generated content of live events has gained popularity and the quality of mobile device video streaming performance has improved, the ability to produce high quality, live-sounding audio reproductions has remained elusive. Regardless of the quality of audio capture on mobile devices, livestream and recorded audio quality taken at live events is limited by the use of a single microphone of each mobile device, typically producing poor-quality audio that does not capture the live experience of live events. Ambient crowd noise, and poor microphone position relative to event speaker systems, can also cause sound degradation issues.

Moreover, when presenting multiple livestream videos of an event to online viewers, the quality of audio in each livestream video may vary from one device to the next, leading to poor audio representation and reduced viewer enjoyment as viewer select different livestreams to watch.

Additionally, the audio timing in each livestream video may be different from other livestream videos, resulting in a disjointed audio representation of an event.

It would be desirable to improve the audio quality of livestream videos as they are watched by online viewers.

### SUMMARY

The embodiments described herein relate to a system, method and apparatus for improving audio quality of livestream videos from live events. In one embodiment, a method is described, performed by an online media production server, comprising receiving a plurality of livestream videos simultaneously from a plurality of spectators at an event, each of the livestream videos comprising an audio component, evaluating each audio component of each livestream to identify one or more audio characteristics of each audio component, select a subset of the audio components for mixing based on the one or more audio characteristics of each of the plurality of audio components, mixing the subset of the audio components to produce a composite audio track and replacing the audio component of each of the livestream videos with the composite audio track while each of the livestream videos are being streamed online.

In another embodiment an media production server is described for enhancing audio quality of livestream videos of live events, comprising a network interface, a non-transitory memory for storing processor-executable instructions and a processor, coupled to the memory and the network interface, for executing the processor-executable instructions that cause the media production server to receive a plurality of livestream videos simultaneously from a plurality of spectators at an event, each of the livestream video comprising an audio component, evaluate each of the plurality of audio components to identify one or more audio characteristics of each audio component, select a subset of the audio components for mixing based on the one or more audio characteristics of each of the plurality of audio components, mix the subset of the audio components to produce a composite audio track and replace the audio component of each of the livestream videos with the composite audio track while each of the livestream videos are being streamed online.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 is a block diagram of a system for improving audio quality of livestream videos sourced at live events;

FIG. 2 is a graphical illustration of one embodiment of how a plurality of audio components are mixed;

FIG. 3 is a functional block diagram of one embodiment of an media production server as shown in FIG. 1;

FIGS. 4A-4B represent a flow diagram illustrating one embodiment of a method for improving the audio quality of livestream videos; and

FIG. 5 is a functional block diagram of one embodiment of an architecture and flowchart of a system for improving audio quality of livestream videos sourced from live events.

### DETAILED DESCRIPTION

Embodiments of the present invention provide technological improvements to video streaming and video-on-demand production technology. Specifically, livestream videos are enhanced by preprocessing and mixing certain audio recordings together. As used herein, “livestream videos” or “streaming videos” comprise video feeds that are streamed across one or more computer networks in the form of a steady, continuous flow, allowing playback to start while the rest of the data is still being received. Livestream videos typically comprise an audio component i.e., a sound track contained in each video. The term “video” generally means video that includes an audio component. While embodiments of the invention are primarily described herein as pertaining to livestream embodiments, the inventive principles described herein can also be applied to recorded audio and video information stored in a memory.

In one embodiment, where a plurality of livestream videos is generated by a plurality of spectators capturing a portion of a live event, a media production server receives the livestream videos in real, or near-real, time, in most cases substantially simultaneously, and processes each of the livestream videos in real or, near-real, time to generate an enhanced, composite audio track that may replace the audio component of each of the livestream videos while each of the livestream videos are being streamed to content viewers online. The composite audio track is generated by evaluating whether any of the livestream videos contain high-quality audio characteristics, or metrics, such as high-quality low tones, high-quality midtones, high-quality high tones, high-quality lead guitar, high-quality bass, high-quality drums, high-quality vocals, high-quality piano, etc. When audio components of two or more livestream videos contain at least one high-quality audio characteristic, the audio components may be combined, or mixed, to include the high-quality characteristics from each audio component. The result is an improved, composite audio track that contains the best audio characteristics of each livestream video.

Embodiments of the invention allow content viewers online to hear a more realistic and rich representation of sound because the composite audio track is based on multiple audio sources, each selected based on quality metrics. This technique overcomes the problem of thin, flat sounds created using only a single microphone from a single source at an event.

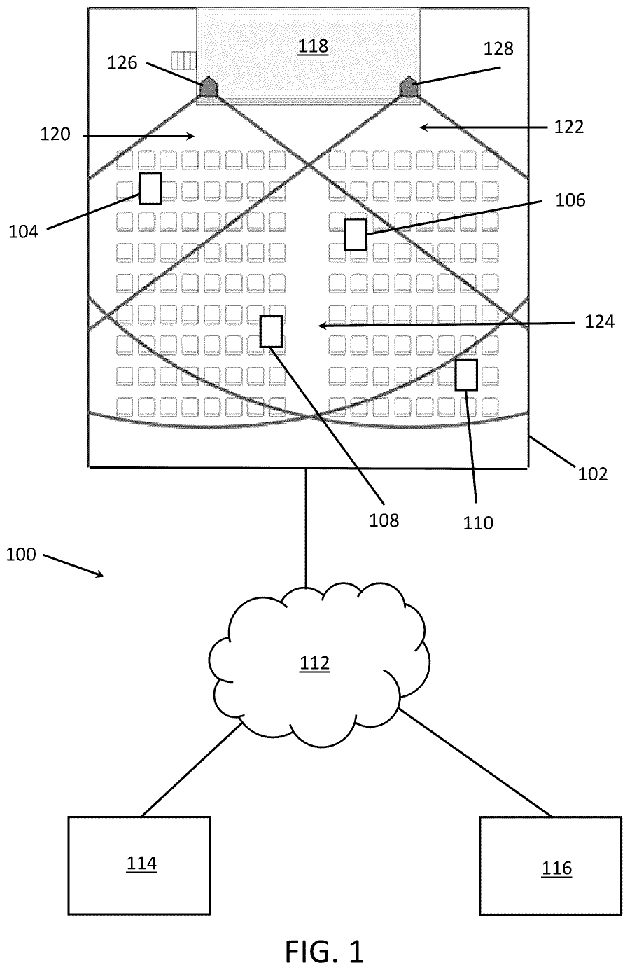

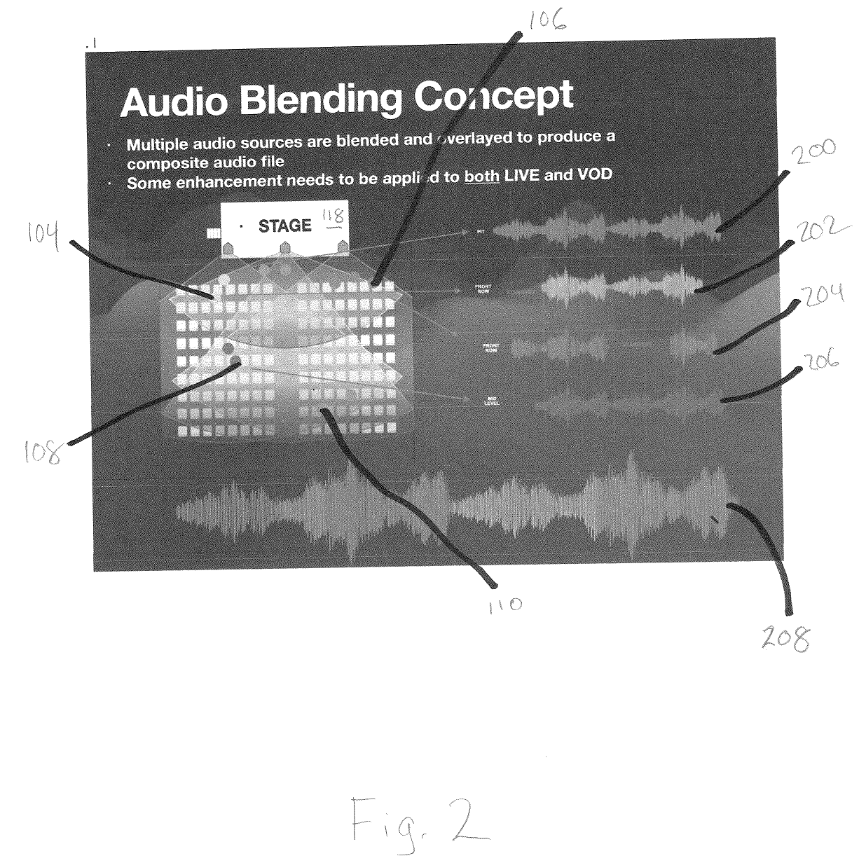

FIG. 1 is a block diagram of a system 100 for improving audio quality of livestream videos received from a plurality of content capture devices at a live event. Shown is venue 102, content capture devices 104, 106, 108 and 110, wide-area network 112, media production server 114, content consumption device 116, stage 118, sonic wave 120, sonic wave 122, sonic overlap 124, loudspeaker 126 and loudspeaker 128.

Venue 102 hosts live events, such as concerts, sporting events, plays, or social events such as parties, weddings, graduations, etc., or some other event typically viewed by a large number of spectators. A “live” event refers to living persons participating in an event, such as musicians, sports players, actors, partygoers, wedding parties, graduates, etc. It should be understood that reference to a live event in progress or a live event that has ended may each be referred to herein as a live event, or simply, an “event” and will be obvious by the context in which each term is used to distinguish between live events in progress or live events that have ended.

The content capture devices shown in FIG. 1 typically comprise personal communication devices outfitted with a camera and a microphone, such as modern mobile phones, wearable devices, digital video cameras, etc. Each content capture device may be capable of operating in a streaming mode, where audio and video of an event is transmitted to media production server 112 via wide-area network 120 in real or near-real, time. Examples of wide-area network 112 comprise the Internet, a cellular mobile phone network, a satellite communication network, etc.

Each content capture device may capture visual and audio information of an event differently than other content capture devices, depending on a location, or vantage point, of each content capture device at venue 102. For example, content capture device 104, located up front at the left side of stage 118, may receive sound primarily from sonic wave 120, due to its proximity in venue 102 to a loudspeaker 126. Thus, the sound captured by content capture device 104 may comprise a very loud, right-channel characteristic and a medium overall sound quality characteristic, comprising very loud low-tone characteristic, a very loud mid-tone characteristic and a very loud high-tone characteristic, but perhaps having a strong distortion characteristic due to limitations of either loudspeaker 126 or audio processing components of content capture device 104. On the other hand, content capture device 106 located up front at the right side of stage 118, may receive sound primarily from sonic wave 122, due to its proximity in venue 102 to a loudspeaker 128. Thus, the sound captured by content capture device 106 may comprise a very loud, right-channel characteristic and a medium overall sound quality characteristic, comprising a very loud low-tone characteristic, a very loud mid-tone characteristic and a very loud high-tone characteristic, but perhaps also having a strong distortion characteristic due to limitations of either loudspeaker 128 or audio processing components of content capture device 104.

Content capture devices 108 and 110 each record video and audio differently than content capture devices 104 and 106, due to their locations within venue 102, with both content capture devices 108 and 110 receiving a mixture of sonic wave 120 and sonic wave 122 at different volumes due to each device's proximity to stage 118 and loudspeakers 126 and 128. Thus, each content capture device captures audio and video differently than each other, each audio component comprising different audio characteristics or metrics at different volumes and quality.

Characteristics, or metrics, of captured audio may comprise one or more of an overall genre (rock, jazz, easy listening), overall volume level, overall sound quality, channel (left, right, center), presence and volume level of low, mid, or high frequencies, quality level of low, mid, or high frequencies, musical instrument type, vocal type (lead singer, backup singers, verse, chorus, etc.), quality level of instruments, quality level of vocals, etc.

Media production server 114 may receive livestream videos simultaneously from spectators during live events, each capturing a portion of an event at the same time. Media production server 114 processes each of the received livestream videos, typically simultaneously, to identify livestream videos that contain high-quality audio characteristics and combine or “mix” two or more audio components of selected livestream videos to produce an improved, composite audio track. The composite audio track may be substituted into each of the livestream videos in real, or near real, time so that each of the livestream videos comprises the improved, composite audio track.

In some embodiments, system 100 is a dynamic system where livestreams are constantly evaluated, selected, filtered and combined. For example, a source of livestream video may stop broadcasting suddenly, may be moving around in an event, suddenly have other people screaming nearby, etc. Thus, system 100 may constantly monitor the streams to alter stream selection at any given time. For example, if media production server 114 begins receiving a new livestream video with high-quality audio characteristics while a composite audio track is being produced, an audio component of the new livestream video may be added to the mix in real, or near-real, time. Similarly, audio components currently being mixed to form the composite audio track may be removed from mixing if the audio characteristics degrade past a certain threshold or if an unwanted audio characteristic appears (such as nearby crowd noise suddenly appearing).

In some embodiments, audio components from livestream videos, and/or the composite audio track, may be analyzed in real, or near-real, time against a reference track, the reference track comprising a song, or other identifiable audio snippet, with desirable audio characteristics, such as a desirable overall tone, “soaring” vocals or lead guitar, an overall “mood” (i.e., bluesey, metal rock, mellow rock, jazzy, etc.) or other desirable audio characteristics. As livestream videos are received, media production server 114 may identify a particular song contained in the livestream video, retrieve a reference track of the identified some and then equalize and otherwise process the audio component of one or more livestream videos and/or the composite audio track. The result is an improved audio track that substantially sonically matches audio characteristics of the reference track.

In one embodiment, a trained AI model is used to automatically process incoming livestream videos to determine audio characteristics of each one and to automatically select two or more of the audio components of the livestream videos for mixing to produce the composite audio track. Training typically comprises providing many thousands of audio tracks, i.e. songs or other audio snippets, to an untrained AI model along with annotations for each track identifying desirable audio characteristics of each track. The AI model may also be trained to select audio components of the livestream videos for mixing that most likely results in a desirable audio experience, as well as to preprocess and actually mix two or more audio components. Examples of an AI model comprise convolutional neural networks, recurrent neural networks and multilayer perceptrons.

Training may be accomplished using publicly-available AI music datasets, such as Coresignal or Success.ai, the datasets comprising typically thousands of tracks and associated metadata describing one or more audio characteristics of each track. AI music datasets are collections of musical data that are used to train and develop artificial intelligence models for various music-related tasks. These tracks serve as a benchmark or standard for an AI system to learn from, essentially providing a target sound quality or style that the AI model should strive to replicate when selecting and mixing audio components of livestream videos, based on the characteristics of the reference audio. These reference tracks act as a guide for the AI model to understand the desired sound quality, tone, pronunciation, or musical style. These datasets typically include a wide range of musical information such as audio recordings, MIDI files, lyrics, and metadata. These datasets are used to teach AI models to understand and generate music, analyze and classify musical elements, recognize and quantify various audio characteristics and perform tasks like music recommendation, composition, transcription, and style transfer. They enable researchers and developers to train AI algorithms to learn patterns, structures, and characteristics of music, allowing them to create intelligent systems that can interact with and create music in a human-like manner.

In one embodiment utilizing artificial intelligence, the trained AI model may be further improved after training by providing individual and/or composite audio tracks (or videos) to the AI model with annotations indicating whether an audio characteristic is present, a level of each audio characteristic, one or more “quality scores” each indicating a relative quality of one or more audio characteristics of an audio component/track as a whole, or individual sections of an audio component/track.

“Mixing” two or more audio components may comprise aligning audio components in time so that each component is synchronized with the others. The components may then be pre-processed by adjusting various audio characteristics of each track, such as by adjusting volume levels of each track at certain frequencies (equalization), reducing peaks of loud sounds and increasing the volume of quiet sounds (compression), adjusting the position of each track within the stereo or surround sound field (panning), reducing noise, etc. Then, the pre-processed components are combined into one or more channels to form a composite audio track.

FIG. 2 is a graphical illustration of one embodiment of how a plurality of audio components arc mixed. Audio components 200, 202, 204 and 206 represent sound recordings in the time domain received by audio processing server 114 from content capture devices 104, 106, 108 and 110 at venue 102, respectively. Each content capture device is located at a different vantage point within venue 102. Each of the sound recordings have been synchronized with each other in time. Each audio track represents sound information recorded by each content capture device at different locations in venue 102, and each track comprises a number of audio characteristics different from the characteristics of other audio components due to the proximity of each device with respect to stage 118 and to each other. Audio track 106 illustrates how content capture device 108 has stopped, and then started, streaming while other content capture devices continue streaming.

In one embodiment, as audio processing server 114 receives the audio components, it processes them in real time to determine characteristics or metrics of each audio track. Each track may be evaluated to determine if it contains any of a predetermined number of characteristics and, if so, determine a level of each characteristic. After each track has been analyzed, one or more of the components may be selected for mixing based on each track's audio characteristics. Generally, audio components, or portions thereof, comprising high quality audio characteristics are selected for mixing. In the example of FIG. 2, each audio component comprises at least one high-quality audio characteristic that exceeds a predetermined threshold for each particular characteristic and therefore, in this example, none are excluded from being mixed together.

Continuing with the example above, audio components 200, 202, 204 and 206 may be preprocessed before being combined with each other, as explained above. After preprocessing, if any, each of the audio components 200, 202, 204 and 206 are mixed with each other using standard mixing techniques well-known in the art, or by using a trained AI model. The result is a composite audio track 208 comprising at least portions of each of audio components 200, 202, 204 and 206. Composite audio track 208 enhances the sound quality of any individual audio track 200, 202, 204 and 206 as mixing the audio components results in a full, “layered” sound that is more immersive and realistic.

Media production server 114 may receive a number of livestream videos from content capture devices both at venue 102 as well as from other content capture devices anywhere in the world. Upon receiving a livestream video, media production server 114 may associate the livestream video with a particular live event occurring as the livestream video is received, based on, for example, a location of a content capture device to known locations where live events are occurring. For example, if media production server 114 receives three livestream videos, one from content capture device 108, another from content capture device 104 and another from a content capture device at a venue different from venue 102, media production server 114 may associate the livestream videos provided by content capture device 104 and 102 with a first live event occurring at venue 102 based on location information provided along with each livestream video, and associate the livestream video received from the other content capture device with a second live event occurring at a different venue.

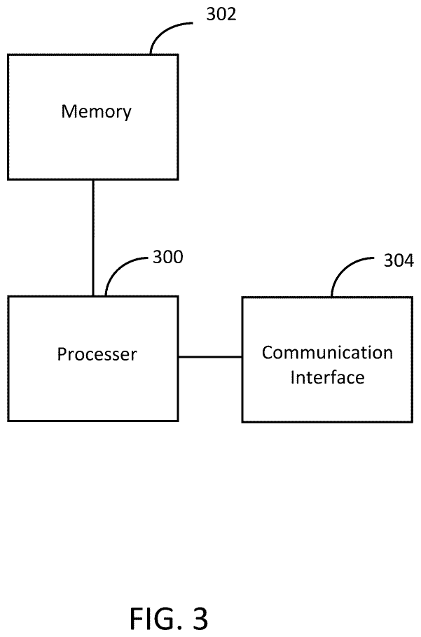

FIG. 3 is a functional block diagram of one embodiment of media production server 114, showing processor 300, memory 302, and communication interface 304. It should be understood that not all of the functional blocks shown in FIG. 3 are required for operation of media production server 114 in some embodiments, that the functional blocks may be connected to one another in a variety of ways, and that not all functional blocks necessary for operation of media production server 114 are shown (such as a power supply), for purposes of clarity.

Processor 300 is configured to provide general operation of media production server 114 by executing processor-executable instructions stored in memory 302, for example, executable computer code. Processor 300 may comprise one of a variety of microprocessors, microcomputers, microcontrollers, SoCs, modules and/or ASICs. Processor 300 may be selected based on a variety of factors, including power-consumption, size, and cost.

Memory 302 is coupled to processor 300 and comprises one or more information storage devices, such as RAM, ROM, flash memory, or some other type of electronic, optical, or mechanical memory device(s). Memory 302 is used to store processor-executable instructions for operation of media production server 114 as well as any information used by processor 300, such as event information including time and location of different events, livestream videos, a listing of audio characteristics and a threshold level of at least some of the audio characteristics, livestream videos, recorded audio or livestream videos, an AI model trained to evaluate livestream videos for audio characteristics and to select audio components from the livestream videos for mixing, and other information used by the various functionalities of media production server 114. It should be understood that memory 302 is non-transitory, i.e., it excludes propagating signals, and that memory 302 could be incorporated into processor 300, for example, when memory processor 300 is an SoC. It should also be understood that once the processor-executable instructions are loaded into memory 302 and are executed by processor 300, media production server 114 may become a specialized computer for improving the sound quality of livestream videos. It should also be understood that the processor-executable instructions improve conventional livestream video and audio processing by providing a mechanism to automatically identify, quantify, select and mix livestream videos in real, or near real, time.

Communication interface 304 is coupled to processor 300, comprising well-known circuitry for allowing media production server 114 to communicate with content capture devices and content consumption devices via a wide-area network 112.

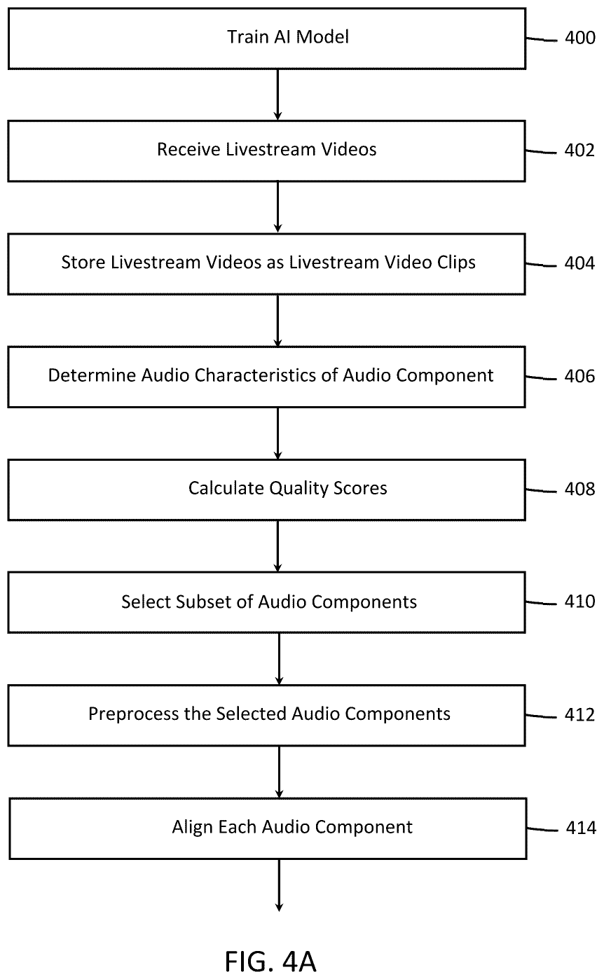

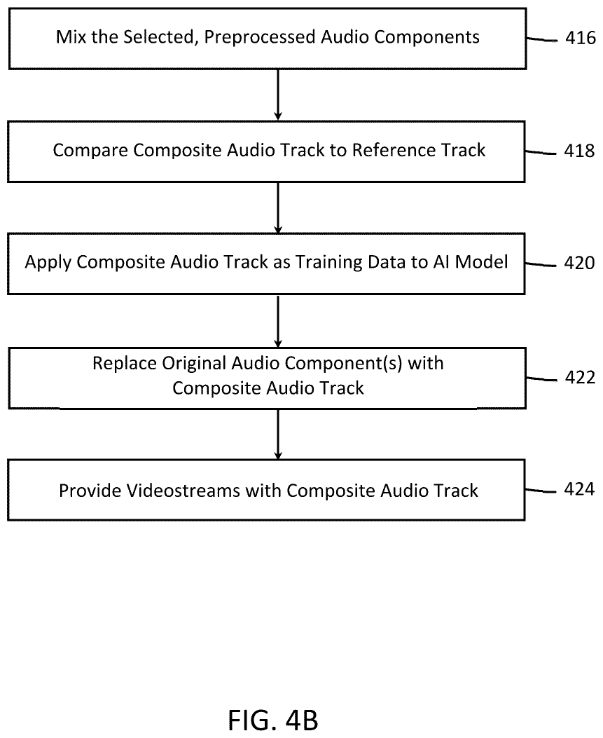

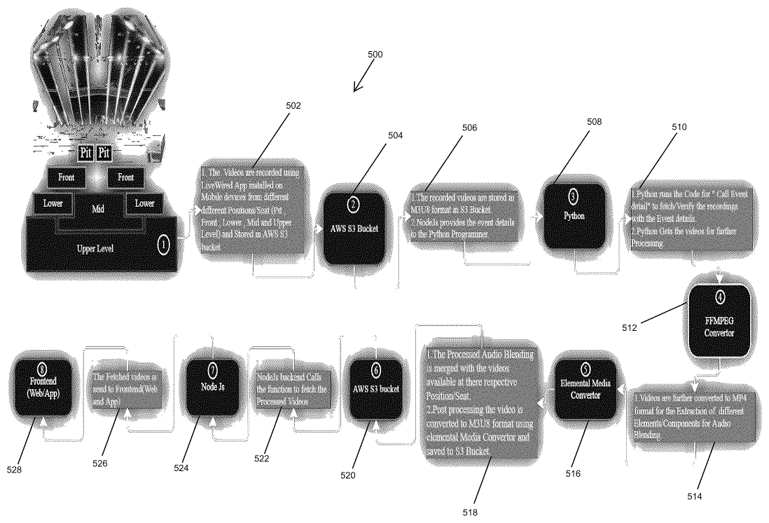

FIGS. 4A-4B represent a flow diagram illustrating one embodiment of a method for improving the audio quality of livestream videos. It should be understood that in some embodiments, not all of the method steps shown in FIGS. 4A and 4B are performed and that the order in which the steps are performed may be different in other embodiments. The method will be described in connection with FIGS. 1 and 2, referring to a particular live event occurring at venue 102. It should also be noted that any method steps relating to media production server 114 may refer to processor 300 executing processor-executable instructions as stored in memory 302 and, in some cases, processor 300 executing processor-executable instructions associated with a trained AI model. It should be understood that the method is equally applicable to pre-recorded audio and video files stored in memory 302.

Step 400, in one embodiment, an artificial intelligence (AI) model may be trained to evaluate livestream videos and to determine one or more audio characteristics, or audio metrics, of an audio component within each livestream video. The model may additionally be trained to select audio components of various livestream videos to produce a combined audio track based on the quality metrics of each audio component. In one embodiment, the AI model is additionally trained to mix one or more selected audio components of the livestream videos and, in some embodiments, additionally preprocess each, selected audio component. The result is a trained AI model.

At step 402, during a live event at venue 102, media production server 114 receives livestream videos from content capture devices located at venue 102 via wide-area network 112 and network interface 304. The livestream videos are generated by each content capture device using either a web-based or device-based software application configured to capture video and audio information of the live event and either record the information and/or stream it to media production server 114. Each livestream video may capture the same portion of the event, however each one may start and end at different times, depending on when a u content capture device began and ended recording. For purposes of discussion, it is assumed that four livestream videos are received substantially simultaneously, capturing a guitar solo of a lead guitar player in a rock band.

At step 404, media production server 114 may store the livestream videos as livestream clips (i.e., audio and/or video clips created from livestream videos) in memory 302 after each livestream video has ended.

At step 406, media production server 114 determines audio characteristics of an audio component of each of the plurality of livestream videos currently being received. This is typically done simultaneously for each audio component. Determining audio characteristics of each audio component may comprise a comparison of each audio component with a listing of audio characteristics stored in memory 302 to determine if any of the audio characteristics are present in each audio component. More than one audio characteristic may be present in any audio component. Media production server 114 may further determine an audio characteristic quality level associated with each audio characteristic found in each of the audio components. In one embodiment, each quality level is associated with a strong volume, or amplitude, of audio in either the time domain or the frequency domain.

For example, memory 302 may store the following audio characteristics: low tones, mid tones, high tones, lead guitar, bass guitar, drums, vocals, piano, volume (either overall or for each of a plurality of frequency bands), extraneous noise (for example, nearby screaming, roars, or other crown noise), overall tone, presence (i.e., referring to a clarity and prominence of a sound, particularly in the upper midrange frequencies around 2-4 kHz, which makes an instrument or voice sound distinct and “forward” in a mix, essentially meaning it cuts through and is easily heard above other sounds), brilliance (i.e., the highest frequency in the audible frequency spectrum from about 6000 Hz to about 20000 Hz that typically contains harmonics. A boost in 7500-10000 Hz can add air, texture, and detail to the sound or music, while the 12000 Hz frequency range can enhance a Hi-Fi environment for recording. However, an excessive 12000 Hz frequency can make a harsh sound), etc. Media production server 114 processes each audio component, in some embodiments, at several different points during each audio component, comparing audio characteristics of each audio component to the list of audio characteristics stored in memory 302. When an audio component comprises one or more of the characteristics, media production server 114 may store an indication in memory 302 of each audio characteristic present in each of the audio components. Media production server 114 may additionally determine a quality level of each characteristic present in each of the audio components, such as to measure a volume associated with each audio characteristic and/or to determine an amplitude of one or more frequency bands of each audio component.

In some cases, an audio component may have portions that have excellent audio quality for a particular audio characteristic, such as a high-quality guitar solo in an otherwise average or below-average overall audio quality. In these cases, media production server 114 may save an indication in memory 302 of a time within an audio component where the high-quality characteristic may be found, so that it may be isolated during mixing as described later herein.

In one embodiment, media production server 114 may determine audio characteristics of each audio component using a trained AI model stored in memory 302. The model may be trained to determine which audio characteristics are present and a quality level of each audio characteristic found in each of the audio components. In some embodiments, for each audio characteristic found, the trained AI model will produce a confidence value indicating the likelihood that each audio characteristic is a) present b) that the determined volume or amplitude has been calculated correctly and/or c) is associated with a correct audio score. In one embodiment, computer code, such as a Python script, may be configured to receive livestream videos, to apply each audio component to the trained AI model, and to store the results in memory 302.

At step 408, once the audio characteristics and associated quality levels have been determined, media production server 114 may calculate one or more quality scores for each of the audio components, or portions thereof, and store the quality levels in memory 302. In one embodiment, an overall quality score may be determined for each of the audio components based on an average, or a weighted average, each of the audio characteristics present. For example, if one audio component comprises four audio characteristics, having audio quality levels of 4, 6, 10, and 2, an average of these quality levels yields an overall quality score of 5.5.

In another example, one or more of the audio characteristics may be weighted to emphasize certain audio characteristics over others. For example, a “vocals” audio characteristic may be weighted twice as much as a “drums” audio characteristic. Here, each audio quality level may be multiplied by its respective weight, as stored in memory 302, to produce a weighted score for each audio characteristic, and then the weighted scores for each audio characteristic may be averaged to produce an average, weighted quality score. Of course, other ways to calculate a quality score for each audio component may be devised without departing from the inventive scope of this embodiment.

Each audio score may be calculated by processor 300 executing processor-executable instructions stored in memory 302. Alternatively, the quality scores may be calculated using the trained AI model (or a different, trained AI model) to automatically analyze each audio component, determine which audio characteristics are present, determine the quality level of each audio characteristic present and calculate one or more quality scores for each audio component.

At step 410, media production server 114 may select one or more audio components for use in creating a composite audio track. Selection may be performed based on a ranking of each audio component's overall quality score, weighted average, some other combination of audio characteristic quality scores, single audio quality characteristic, etc. Ranking may be relative or based on predefined quality characteristic thresholds stored in memory 302. Selection may also be performed by accessing memory 302 to determining one or more times in any of the audio components where high-quality audio may be found, for example, a high-quality guitar solo in an otherwise mediocre audio component that would not normally be selected. In this case, the mediocre portion may be attenuated before such an audio component is combined with other audio components.

For example, if eight audio components are being processed simultaneously by media production server 114, audio components having the top three overall quality scores may be selected for creating the composite audio track. Alternatively, any of the eight audio components that have an overall quality score greater than “7” may be selected for creating the composite audio track. In another embodiment, media production server 114 attempts to identify at least one high-quality audio component for each of a predetermined number of audio characteristics. For example, it may be desirable to create a composite audio track with audio components having a minimum of the following audio characteristics: high-quality vocals, high-quality bass and high-quality guitar. In this example, media production server 114 may select a first audio component of the eight audio components comprising the highest-quality vocals of the eight audio components, a second audio component comprising the highest-quality bass of the 8 audio components and a third audio component comprising the highest-quality guitar of the eight audio components. In yet another embodiment, audio components are selected based on whether one or more audio characteristics exceed a minimum audio quality threshold, respectively, stored in memory 302.

At step 412, media production server 114 may preprocess each of the selected audio components streams before mixing. Preprocessing may comprise equalizing (i.e., adjusting a volume of a plurality of frequency bands), panning (i.e., moving a sound anywhere in a stereo field of a stereo playback system. With panning, sound sources can be placed in a way that they are perceived as coming from a left speaker, a right speaker, or from anywhere in between), compression (i.e., adjusting a dynamic range), noise reduction, etc.

Media production server 114 may preprocess the selected audio components based on predefined presets stored in memory 302. For example, if each audio component is evaluated based on ten frequency bands, memory 302 may store a predetermined volume level for each of the ten frequency bands. Media production server 114 may then adjust the volume level for each of the ten frequency bands of the audio component to match the volume levels stored for each frequency in memory 302.

In another embodiment, equalization may comprise increasing a volume level of a first audio component during a time when a first audio characteristic of the first audio component during the time exceeds a second audio characteristic of a second audio component of the subset of audio components during the time. For example, during a portion of an event, two livestream videos capture the same thirty seconds of the event.

In one embodiment, media production server 114 may preprocess audio components using panning techniques. In this embodiment, media production server 114 may determine a location, or vantage point, of where each audio component was recorded at venue 102. The location may be determined by evaluating location metadata provided with each livestream video. The location may be general or more particular. For example, the location may comprise “front row”, left, middle and right floor, left middle and right mezzanine, left, middle and right upper level, “section 31, row L, seat 20”, etc. For each audio component, media production server 114 may use the location metadata to adjust a right channel volume and/or a left channel volume to match expected left and right channel levels for each location within venue 102. Memory 302 may store a number of left and right channel volume levels for various locations within venue 102.

In one embodiment, media production server 114 may preprocess audio components using audio compression techniques, i.e., adjusting a dynamic range of volume reduce to the volume during loud portions and increasing the volume during quiet portions. A preferred dynamic range may be stored in memory 302, and media production server 114 may use the preferred dynamic range to make adjustments to each of the audio components.

In one embodiment, for any of the preprocessing described above, a reference track may be used to made adjustments to the audio components. In this embodiment, media production server 114 identifies a song or musical piece represented by the audio components using techniques known in the art such as Spotify, and may retrieve a reference track from memory 302 or from a computer server over wide-area network 112. In either case, one or more collections of reference tracks may be defined and stored, such as collections comprising reference tracks containing tracks of different music genres, respectively, a collection of professionally mixed studio recordings, a collection of reference tracks from one or more publicly-available music streaming services such as iTunes or Spotify. The reference track typically comprises an ideal version of each song, typically performed by an original artist, with various audio characteristics adjusted for an optimal listening experience. Media production server 114 may use a reference track in an attempt to match equalization levels, panning levels, compression levels, etc. of the reference track.

At step 414, media production server 114 typically aligns each of the selected audio components with each other, i.e., the selected audio components are synchronized so that they represent the same portion of the event at the same time. Synchronization may be needed when one or more livestream videos are delayed due to a variety of technical reasons, where each livestream video may be received by media production server 114 at slightly different times. Synchronization may comprise identifying a pattern of audio information in an audio component in the time domain and matching the pattern to audio information in other audio components.

In any case, at step 416, media production server 114 mixes the selected, preprocessed audio components to yield a composite audio track. Mixing may be performed by processor 300 executing processor-executable instructions as stored in memory 302, or may be performed by the trained AI model mentioned earlier. The composite audio track comprises a mixing of the selected audio components so that the overall sound of the composite audio track creates an immersive, realistic listening experience.

At step 418, media production server 114 may compare the composite audio track to a reference track to adjust various audio characteristics of the composite audio track, similar to using a reference track as described above with respect to individual audio components.

At step 420, in one embodiment, the composite audio track may be used as training data to additionally train the AI model. This allows the AI model to adapt to changing audio patterns and improve its accuracy over time. For example, additionally training the AI model may allow it to learn new audio patterns and better recognize or generate sounds, like speech, music, or environmental noises, and to produce better-sounding composite audio tracks for different environments/venues/conditions and for different types of music. In one embodiment, the composite audio track is compared to a reference track to determine how closely the composite audio track matches the reference track, i.e., how closely the levels and frequencies match levels and frequencies of the reference track. Based on this comparison, an indication of an overall audio quality level, or indications of particular audio quality levels of one or more audio characteristics of the composite audio track may be used as metadata and provided to the AI model along with the composite audio track, and the AI model processes the composite audio track and the metadata to improve its predictive capabilities.

At step 422, each audio component of each of the livestream videos being streamed to online viewers may be seamlessly replaced by the composite audio track. For example, if a first livestream video is being streamed online from media production server 114, and the composite audio track becomes available fifteen seconds into the livestream, media production server 114 may seamlessly stop streaming the audio component of the livestream video and begin streaming the composite audio track at the fifteen second mark.

At step 424, media production server 114 streams the livestream videos, each with the composite audio track, to online viewers via network interface 304, wide-area network 112 and each viewer's content consumption device 116.

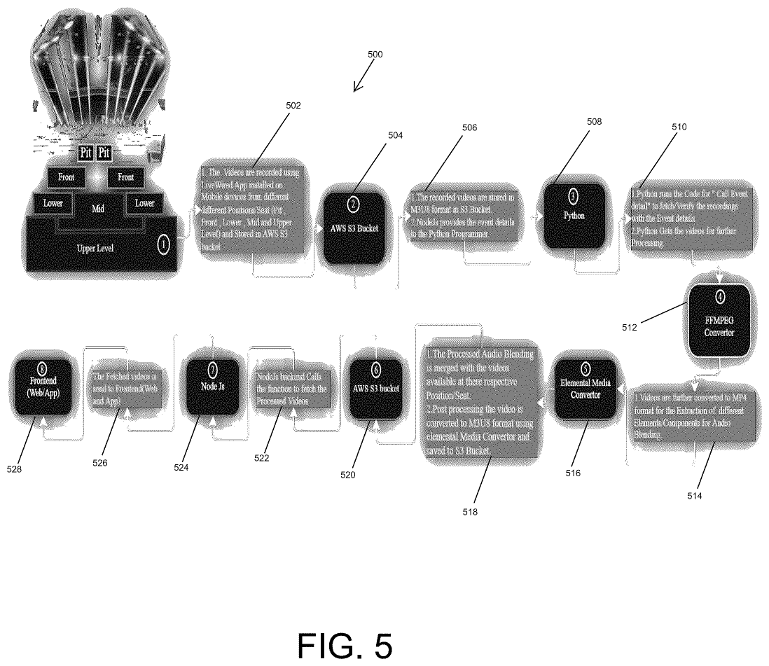

FIG. 5 is a functional block diagram of one embodiment of an architecture and flowchart of a system 500 for improving audio quality of livestream videos sourced from live events. Livestream videos from venue 102 created by personal recording devices such as content capture devices 104 through 110 as shown in FIG. 1 (502). The livestream videos may be routed to an online file storage system 504, such as Amazon's AWS S3 file storage system where they may be stored. The livestream videos and associated metadata, such as location where each livestream video was recorded inside venue 102, may be stored in a particular data format, such as M3U8 format (506).

A run-time environment 508, such as a NodeJs environment, may be stored in memory 302 and executed by processor 300 to retrieve the livestream videos, in some embodiments, in real, or near-real, time from the file storage system, as well as the associated metadata.

Processor-executable instructions stored in memory 302, such as instructions in accordance with the well-known programming language Python, cause processor 300 to call a function that may associate two or more livestream videos with each other, in accordance with the metadata showing that each livestream video was provided from the same venue at approximately the same time (510).

The livestream videos may then be converted into another video format, in this example, into an MP4 file using an FFMPEG converter 512.

Next, audio components of each livestream video may be identified and/or separated from each respective livestream video by processor 300 in order to determine audio characteristics of each audio component. A subset of livestream videos is selected by processor 300 based on desirable audio characteristics of each livestream video. The subset of livestream videos may then be preprocessed i.e. equalized, panned, compressed, noise reduced, etc., in some embodiments, using a reference track stored in a database such as the AWS S3 file storage system. The preprocessed subset of livestream videos is then combined, or mixed, to create a composite audio track. The composite audio track may then replace the original audio component of each of the subset of livestream videos (514).

The composite audio track may then be converted back into another format suitable for transmission over wide-area network 112, such as back to the M3U8 format using an online service such as Amazon's Elemental Media Converter 516 and then provided to the AWS S3 file storage system (518, 520).

The NodeJs environment 524 (or the same run-time environment 508) may then retrieve the livestream videos with the composite audio track (522) and provide them to a Web server 528 used to view the livestream videos or to an app executed by a content consumption device 116 (526).

Although specific advantages have been enumerated above, various embodiments may include some, none, or all of the enumerated advantages. Other technical advantages may become readily apparent to one of ordinary skill in the art after review of the foregoing figures and description.

It should be understood at the outset that, although exemplary embodiments are illustrated in the figures and described above, the principles of the present disclosure may be implemented using any number of techniques, whether currently known or not. The present disclosure should in no way be limited to the exemplary implementations and techniques illustrated in the drawings and described above.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set. The article “a” means “one or more”.

In many places in this document, actions (e.g., functionality) are performed by one or more processors executing processor-executable instructions (i.e., software, firmware). This is done for case of description; it should be understood that, whenever it is described in this document that software performs any action, the action is in actuality performed by underlying hardware elements (such as a processor and a memory device) according to the instructions that comprise the software. Such functionality may, in some embodiments, be provided in the form of firmware and/or hardware implementations.

As used herein, the term LLM or large language model, includes other types of models. Accordingly, whenever it is mentioned herein that an LLM may be used, other types of models may also be used. The models may be neural networks or other types of machine-learned models that provide an output (e.g., a predictive output) from a given input. When prompted, inference may be performed on the indicated model (e.g., the LLM) that then provides a response.

The elements described in this document include actions, features, components, items, attributes, and other terms. Whenever it is described in this document that a given element is present in “some embodiments,” “various embodiments,” “certain embodiments,” “certain example embodiments, “some example embodiments,” “an exemplary embodiment,” “an example,” “an instance,” “an example instance,” or whenever any other similar language is used, it should be understood that the given element is present in at least one embodiment, though is not necessarily present in all embodiments. Consistent with the foregoing, whenever it is described in this document that an action “may,” “can,” or “could” be performed, that a feature, element, or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, clement, component, attribute, etc. is present in at least one embodiment, though is not necessarily present in all embodiments.

Terms and phrases used in this document, and variations thereof, unless otherwise expressly stated, should be construed as open-ended rather than limiting. As examples of the foregoing: “and/or” includes any and all combinations of one or more of the associated listed items (e.g., a and/or b means a, b, or a and b); the singular forms “a”, “an”, and “the” should be read as meaning “at least one,” “one or more,” or the like; the term “example”, which may be used interchangeably with the term embodiment, is used to provide examples of the subject matter under discussion, not an exhaustive or limiting list thereof; the terms “comprise” and “include” (and other conjugations and other variations thereof) specify the presence of the associated listed elements but do not preclude the presence or addition of one or more other elements; and if an element is described as “optional,” such description should not be understood to indicate that other elements, not so described, are required.

As used herein, the term “non-transitory computer-readable storage medium” includes a register, a cache memory, a ROM, a semiconductor memory device (such as D-RAM, S-RAM, or other RAM), a magnetic medium such as a flash memory, a hard disk, a magneto-optical medium, an optical medium such as a CD-ROM, a DVD, or Blu-Ray Disc, or other types of volatile or non-volatile storage devices for non-transitory electronic data storage. The term “non-transitory computer-readable storage medium” does not include a transitory, propagating electromagnetic signal.

The claims are not intended to invoke means-plus-function construction/interpretation unless they expressly use the phrase “means for” or “step for.” Claim elements intended to be construed/interpreted as means-plus-function language, if any, will expressly manifest that intention by reciting the phrase “means for” or “step for”; the foregoing applies to claim elements in all types of claims (method claims, apparatus claims, or claims of other types) and, for the avoidance of doubt, also applies to claim elements that are nested within method claims. Consistent with the preceding sentence, no claim element (in any claim of any type) should be construed/interpreted using means plus function construction/interpretation unless the claim clement is expressly recited using the phrase “means for” or “step for.”

Whenever it is stated herein that a hardware element (e.g., a processor, a network interface, a display interface, a user input adapter, a memory device, or other hardware clement), or combination of hardware elements, is “configured to” perform some action, it should be understood that such language specifies a physical state of configuration of the hardware element(s) and not mere intended use or capability of the hardware element(s). The physical state of configuration of the hardware elements(s) fundamentally ties the action(s) recited following the “configured to” phrase to the physical characteristics of the hardware element(s) recited before the “configured to” phrase. In some embodiments, the physical state of configuration of the hardware elements may be realized as an application specific integrated circuit (ASIC) that includes one or more electronic circuits arranged to perform the action, or a field programmable gate array (FPGA) that includes programmable electronic logic circuits that are arranged in series or parallel to perform the action in accordance with one or more instructions (e.g., via a configuration file for the FPGA). In some embodiments, the physical state of configuration of the hardware element may be specified through storing (e.g., in a memory device) program code (e.g., instructions in the form of firmware, software, etc.) that, when executed by a hardware processor, causes the hardware elements (e.g., by configuration of registers, memory, etc.) to perform the actions in accordance with the program code.

A hardware element (or elements) can therefore be understood to be configured to perform an action even when the specified hardware element(s) is/are not currently performing the action or is not operational (e.g., is not on, powered, being used, or the like). Consistent with the preceding, the phrase “configured to” in claims should not be construed/interpreted, in any claim type (method claims, apparatus claims, or claims of other types), as being a means plus function; this includes claim elements (such as hardware elements) that are nested in method claims.

Although process steps, algorithms, or the like, may be described or claimed in a particular sequential order, such processes may be configured to work in different orders. In other words, any sequence or order of steps that may be explicitly described or claimed in this document does not necessarily indicate a requirement that the steps be performed in that order; rather, the steps of processes described herein may be performed in any order possible. Further, some steps may be performed simultaneously (or in parallel) despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary, and does not imply that the illustrated process is preferred.

Although various embodiments have been shown and described in detail, the claims are not limited to any particular embodiment or example. None of the above description should be read as implying that any particular element, step, range, or function is essential. All structural and functional equivalents to the elements of the above-described embodiments that are known to those of ordinary skill in the art are expressly incorporated herein by reference and are intended to be encompassed. Moreover, it is not necessary for a device or method to address each and every problem sought to be solved by the present invention, for it to be encompassed by the invention. No embodiment, feature, element, component, or step in this document is intended to be dedicated to the public.

What is claimed is:

1. A method, performed by an online media production server, for improving audio quality of livestream videos sourced from live events, comprising:
receiving a plurality of livestream videos substantially simultaneously from a plurality of spectators at an event, each of the livestream videos comprising an audio component;
evaluating each of the audio components of each livestream video to identify one or more audio characteristics of each audio component;
selecting a subset of the audio components for mixing based on the one or more audio characteristics of each of the plurality of audio components;
mixing the subset of the audio components to produce a composite audio track; and
replacing the audio component of each of the livestream videos with the composite audio track while each of the livestream videos are being streamed online.

2. The method of claim 1, wherein mixing the subset of the audio components comprises:
aligning each of the selected audio components in time;
increasing a gain of a first audio component of the subset of audio components during a time when a first audio characteristic of the first audio component during the time exceeds a second audio characteristic of a second audio component of the subset of audio components during the time; and
adding the gain-increased first audio component and the second audio component together to produce the composite audio track.

3. The method of claim 1, wherein selecting the subset of the audio components comprises:
defining one or more audio characteristic thresholds each associated with one of the one or more audio characteristics;
determining, for each of the plurality of audio components, one or more audio characteristic levels;
selecting a first audio component for mixing when a first audio characteristic level exceeds a first audio characteristic threshold; and
selecting a second audio component for mixing when a second audio characteristic level of a second audio characteristic exceeds a second audio characteristic threshold.

4. The method of claim 1, wherein selecting the subset of the audio components comprises:
calculating, for each of the plurality of audio components, an audio score comprising a weighted sum of one or more of the audio characteristic levels;
selecting a first audio component for mixing when a first audio score of one of the plurality of audio components is greater than audio scores of any other audio component; and
selecting a second audio component for mixing when a second audio score of another of the plurality of audio components is greater than audio scores of each of the remaining audio components.

5. The method of claim 1, further comprising:
training a machine learning model to:
determine one or more audio characteristic levels of the plurality of audio components; and
select one or more of the plurality of audio components for mixing based on the one or more audio characteristic levels.

6. The method of claim 1, further comprising:
identifying a song from one or more of the plurality of audio components;
comparing the composite audio track to a reference song associated with the song; and
equalizing the composite audio track to match amplitudes and frequencies of the reference song.

7. The method of claim 1, further comprising:
training a machine learning model to:
identify a song from one or more of the plurality of audio components;
compare the composite audio track to a reference song associated with the song; and
equalize the composite audio track to match a sonic tone of the reference song.

8. The method of claim 1, further comprising:
receiving a first livestream video while the composite audio track is being provided online, the first livestream video comprising a first audio component;
analyzing the first audio component to determine an audio characteristic of the first audio component;
determining that the audio characteristic exceeds an audio quality threshold; and
mixing the first audio component with the subset of audio components to produce the composite audio track.

9. The method of claim 1, further comprising:
receiving a first livestream video while the composite audio track is being provided online, the first livestream video comprising a first audio component;
analyzing the first audio component to determine an audio characteristic of the first audio component; and
substituting one of the selected audio components of the subset of audio components with the first audio component during mixing when the audio characteristic of the first audio component exceeds an audio characteristic of one of the subset of audio components.

10. The method of claim 1, further comprising:
as the livestream videos with the composite audio track is being provided online, continuing to evaluate each of the plurality of audio components to identify when an audio characteristic of any of the plurality of audio components degrades past a predetermined quality threshold;
identifying a first audio component comprising an audio characteristic that has degraded past the predetermined quality threshold; and
removing the first audio component from being mixed with the subset of audio components when the audio characteristic of the first audio component has degraded past the predetermined quality threshold.

11. A media production server for improving audio quality of livestream videos sourced from live events, comprising:
a network interface;
a non-transitory memory for storing processor-executable instructions; and
a processor, coupled to the memory and the network interface, for executing the processor-executable instructions that cause the media production server to:
receive a plurality of livestream videos simultaneously from a plurality of spectators at an event, each of the livestream videos comprising an audio component;
evaluate each of the audio components to identify one or more audio characteristics of each audio component;
select a subset of the audio components for mixing based on the one or more audio characteristics of each of the plurality of audio components;
mix the subset of the audio components to produce a composite audio track; and
replace the audio component of each of the livestream videos with the composite audio track while each of the livestream videos are being streamed online.

12. The media production server of claim 11, wherein the processor-executable instructions that causes the media production server to mix the subset of the audio components comprises instructions that cause the media production server to:
align each of the selected audio components in time;
increase a gain of a first audio component of the subset of audio components during a time when a first audio characteristic of the first audio component during the time exceeds a second audio characteristic of a second audio component of the subset of audio components during the time; and
add the gain-increased first audio component and the second audio component together to produce the composite audio track.

13. The media production server of claim 11, wherein the processor-executable instructions that causes the media production server to select the subset of the audio components comprises instructions that causes the media production server to:
define one or more audio characteristic thresholds each associated with one of the one or more audio characteristics;
determine, for each of the plurality of audio components, one or more audio characteristic levels;
select a first audio component for mixing when a first audio characteristic level exceeds a first audio characteristic threshold; and
select a second audio component for mixing when a second audio characteristic level of a second audio characteristic exceeds a second audio characteristic threshold.

14. The media production server of claim 11, wherein the processor-executable instructions that causes the media production server to select the subset of the audio components comprises instructions that causes the media production server to:
calculate, for each of the plurality of audio components, an audio score comprising a weighted sum of one or more of the audio characteristic levels;
select a first audio component for mixing when a first audio score of one of the plurality of audio components is greater than audio scores of any other audio component; and
select a second audio component for mixing when a second audio score of another of the plurality of audio components is greater than audio scores of each of the remaining audio components.

15. The media production server of claim 11, further comprising additional processor-executable instructions that causes the media production server to:
train a machine learning model to:
determine one or more audio characteristic levels of the plurality of audio components; and
select one or more of the plurality of audio components for mixing based on the one or more audio characteristic levels.

16. The media production server of claim 11, further comprising additional processor-executable instructions that causes the media production server to:
identify a song from one or more of the plurality of audio components;
compare the composite audio track to a reference song associated with the song; and
equalize the composite audio track to match amplitudes and frequencies of the reference song.

17. The media production server of claim 11, further comprising additional processor-executable instructions that causes the media production server to:
train a machine learning model to:
identify a song from one or more of the plurality of audio components;
compare the composite audio track to a reference song associated with the song; and
equalize the composite audio track to match a sonic tone of the reference song.

18. The media production server of claim 11, further comprising additional processor-executable instructions that causes the media production server to:
receive a first livestream video while the composite audio track is being provided online, the first livestream video comprising a first audio component;
analyze the first audio component to determine an audio characteristic of the first audio component;
determine that the audio characteristic exceeds an audio quality threshold; and
mix the first audio component with the subset of audio components to produce the composite audio track.

19. The media production server of claim 11, further comprising additional processor-executable instructions that causes the media production server to:
receive a first livestream video while the composite audio track is being provided online, the first livestream video comprising a first audio component;
analyze the first audio component to determine an audio characteristic of the first audio component; and
substitute one of the selected audio components of the subset of audio components with the first audio component during mixing when the audio characteristic of the first audio component exceeds an audio characteristic of one of the subset of audio components.

20. The media production server of claim 11, further comprising additional processor-executable instructions that causes the media production server to:
as the livestream videos with the composite audio track is being provided online, continue to evaluate each of the plurality of audio components to identify when an audio characteristic of any of the plurality of audio components degrades past a predetermined quality threshold;
identify a first audio component comprising an audio characteristic that has degraded past the predetermined quality threshold; and
remove the first audio component from being mixed with the subset of audio components when the audio characteristic of the first audio component has degraded past the predetermined quality threshold.
